(19) United States
(12) Patent Application Publication
(10) Pub. No.: US 2006/0003633 A1
(43) Pub. Date: Jan. 5, 2006

(54) Shield wire

(75) Inventor: Kenji Wada, Fujimi-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/146,148

(22) Filed: Jun. 7, 2005

(30) Foreign Application Priority Data
Jul. 2, 2004 (JP) 2004-196758

(51) Int. Cl. H01R 31/06

(52) U.S. Cl. 439/628

(57) ABSTRACT

A shield wire includes a first conductive wiring that is formed by discharging with a droplet discharging device, for passing electric current or an signal; a second conductive wiring that is formed by discharging with a droplet discharging device; and an insulating portion formed between the first conductive wiring and the second conductive wiring by discharging with a droplet discharging device.

### BACKGROUND

The present invention relates to a technology of producing a shield wire on a circuit board and the like.

Various countermeasures against reducing noise generated from electronic instruments were proposed as accompanied with fast development of electronics. Fro example, a mesh-patterned conductive film is formed by an ink jet method on a glass in a building like a hospital that needs electromagnetic shielding, preventing intra precision apparatus from malfunctioning (refer to Japanese Unexamined Patent Application Publication No. 2003-318593.) Processing the end of a coaxial cable is improved (refer to Japanese Unexamined Patent Application Publication No. 8-45363.) Shield flat cables are provided avoiding cross talk, improving electrical property, and being easily manufactured (refer to Japanese Unexamined Patent Application Publication No. 2000-173355.)

Meanwhile, coaxial cables and shield flat cables are to connect electronic elements within an electronic instrument with holding electromagnetic shield, and their sizes are bottleneck for miniaturizing an electronic instrument.

### SUMMARY

In view of the above problem, the present invention is intended to produce a shield wire by a ink jet method on a circuit board and the like used for an electronic instrument and provide an shield wire by which an countermeasure against noise is easily taken in an electronic instrument.

According to an aspect of the present invention, a shield wire comprises a first conductive wiring that is formed by discharging with a droplet discharging device, for passing electric current or an signal; a second conductive wiring that is formed by discharging with a droplet discharging device; and an insulating portion formed between the first conductive wiring and the second conductive wiring by discharging with a droplet discharging device.

According to this structure, a shield wire has a first conductive wiring that is formed by discharging with a droplet discharging device, for passing electric current or an signal; a second conductive wiring that is formed around the first wiring by discharging with a droplet discharging device; an insulating portion formed between the first conductive wiring and the second conductive wiring and electrically isolates the first wiring from the second wiring. The insulating portion forms electrical insulation between the first conductive wiring and the second conductive wiring.

It is preferable that a shield wire is provided with an insulating layer that is formed by discharging with a droplet discharging device, between the second conductive wiring and a discharged member that is formed by discharging with the droplet discharging device.

According to this structure, an insulating layer that is formed between the second conductive wiring and a conductive wiring included in a discharged member by discharging with a droplet discharging device, and electrically insulates the second wire from the conductive wiring included in a discharged member.

It is preferable that a shield wire is provided with a discharged member, which is a circuit board.

According to the structure, the shield wire connects electronic elements together, which are mounted on the discharged member.

It is preferable that a shield wire is provided with a discharged member which is a container of an electronic instrument.

According to the structure, the shield wire connects circuit boards together, which are mounted on the discharged member.

It is preferable that a shield wire has a discharged member that is an electronic element.

According to the structure, a shield wire can connect other portion on the circuit board over electronic elements, which are mounted on the discharged member since a discharged member is an electronic element.

It is preferable that a shield wire has a plurality of insulating portions formed between the first conductive wirings and the second conductive wirings.

According to the structure, the second conductive wiring encompasses a plurality of insulating portions corresponding to a plurality of the first conductive wirings and the first conductive wirings so as to electrically connect a plurality of wirings.

It is preferable that a shield wire is provided with a second conductive wiring, which is electrically grounded.

Electrical noise due to current and signal passing through the first conductive wiring within the second conductive wiring can be shielded since the second conductive wiring is electrically grounded.

### BRIEF DESCRIPTION OF THE DRAWINGS

The invention is described with reference to the accompanying drawings, wherein like numbers reference like elements, and wherein:

FIG. 1 is a perspective view of a droplet discharging device 1,

FIG. 2A is a sectional perspective view of a droplet discharging head 51,

FIG. 2B is a detail sectional view of discharging portion,

FIG. 3A is a partial plane view of a shield wire installed in a circuit board,

FIG. 3B is a partial cross sectional view of a shield wire installed in a circuit board or a container of an electronic instrument,

FIG. 4 is a partial enlarging view of the shield wire 30 in the embodiment 2,

FIG. 5 is a perspective view of installing the shield wire 30 in a container of an electronic device,

FIG. 6A is a plane view of electronic elements mounted on the circuit board 10A in the embodiment 4, which is a discharged member of the shield wire 30 and

FIG. 6B is a partial cross sectional view in the embodiment 4

### DETAILED DESCRIPTION OF EMBODIMENTS

### First Embodiment

A first embodiment of the invention will now be described with reference to the accompanying drawings.

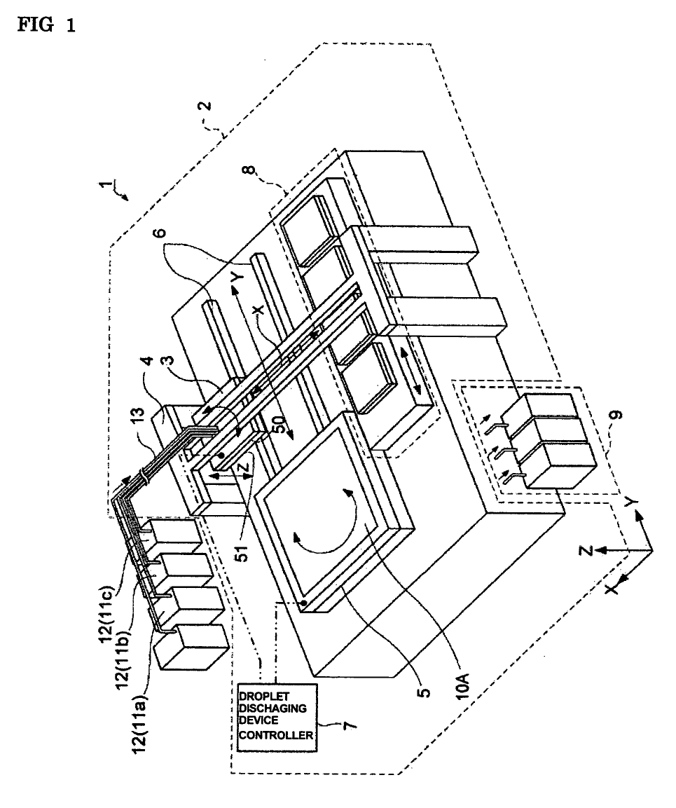

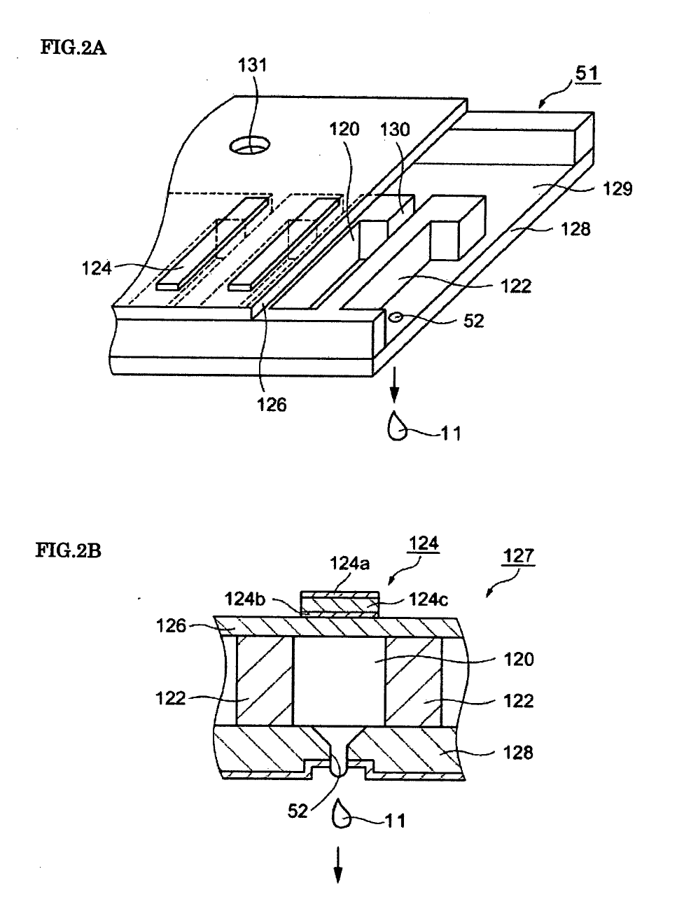

FIG. 1 is a perspective view of a droplet discharging device 1. In the figure, the droplet discharging device 1 comprises plurality of tanks 12 maintaining a first conductive liquid material 11a, an insulating liquid material 11b, a second conductive insulating material 11c, a tube 13 and a discharging scan portion 2 which supplies a first conductive liquid material 11a, an insulating liquid material 11b, and a second conductive insulating material 11c from the tanks 12 via the tube 13. The discharging scan portion 2 comprises a sub carriage 50 maintaining a plurality of droplet discharge heads 51 (details are shown in FIG. 2), a carriage 3 holding the sub carriage 50, a second position control device 4 controlling a position of the carriage 3, a stage 5 holding a circuit board 10A on which an electronic element is mounted or an electronic element is not mounted, a first position control device 6 controlling the position of the stage 5, a droplet discharging device control portion 7, a maintenance device 8 and a draining device 9. The tank 12 is connected to the plurality of droplet discharge heads 51 in the carriage 3 via the tube 13 and the tank 12 supplies a first conductive liquid material 11a, an insulating liquid material 11b, a second conductive insulating material 11c to each of the droplet discharge heads 51. Details of the above materials are described later.

The second position control device 4 changes the relative position of the carriage 3 toward X-axis and Z-axis perpendicular to Z-axis in response to a signal from the droplet discharging device control portion 7. Further, the second position control device 4 makes the carriage 3 rotate around the axis, which is parallel to Z-axis. In the embodiment, Z-axis is approximately parallel to vertical direction (namely the gravitational acceleration direction.) The first position control device 6 changes the relative position of the stage 5 toward Y-axis direction, which is perpendicular to X-axis and Z-axis in response to a signal from the droplet discharging device control portion 7. Further, the first position control device 6 makes the stage 5 rotate around Z-axis. In the specification, the second position control device 4 and the first position control device 6″ may be referred to as “scan portion”.

The stage 5 has a plane, which is in parallel to both X-axis and Y-axis. The stage 5 is constituted so as to place or hold the circuit board 10A detachable, which is coated with the first conductive liquid material 11a, the insulating liquid material 11b, and the second conductive insulating material 11c.

The circuit board 10A in the figure is an electronic circuit device having a plurality of conductive wirings. The embodiment is applied not only to an electronic circuit device in which various electronic parts are mounted, but also to only the circuit board 10A. The wiring included in the circuit board 10A is explained as a single layer hereafter, but the embodiment is also applied to a multi layered circuit board. Further, the first conductive liquid material 11a, the insulating liquid material 11b, and the second conductive insulating material 11c, which are discharged from the droplet discharging head 51, are a liquid state directly after discharging. These materials are solidified by thermal or optical treatment after discharging, depending on a used solvent. In the specification, “form” may mean that these liquid materials are discharged by the droplet discharging head 51 so as to form a specific configuration with a predetermined thickness and solidified by thermal or optical treatment after discharging.

Further, X-axis direction, Y-axis direction and Z-axis direction are coincided to the direction where the relative position of any of the carriage 3 and the stage 5 is changed. Further, virtual original points of the XYZ coordinate system defining X-axis, Y-axis and Z-axis are fixed to the reference portion of the droplet discharging device 1. In the specification, X-axis, Y-axis and Z-axis are a coordinate on the XYZ coordinate system. Here, the above virtual original points may be fixed on the stage 5 or the carriage 3.

The carriage 3 and the stage 5 have a further freedom of changing relative displacements and rotations more than the above. Here, in the embodiment, the explanation of this further freedom more than the above is omitted.

The droplet discharging device control portion 7 is constituted so as to receive discharge data indicating the relative position for discharging the first conductive liquid material 11a, the insulating liquid material 11b, and the second conductive insulating material 11c from an external information processing device (not shown.)

In the maintenance device 8, a unit for performing maintenance to some of drop discharging heads 51 is installed and selected by the droplet discharging device control portion 7. The unit is stopped after changing the relative position toward Y direction corresponding to the carriage 3. When performing maintenance to the drop discharging heads 51, the relative position of the carriage 3 is changed along X direction on the maintenance device 8 by the second position control device 4. A desired unit is positioned at the carriage 3 by moving the maintenance device 8 and selected so as to change the relative position. Further, the draining device 9 collects each of the first conductive liquid material 11a, the insulating liquid material 11b, and the second conductive insulating material 11c, which are collected by each unit of the droplet discharging device 1.

FIG. 2A is a sectional perspective view of the droplet discharge head 51 and FIG. 2B is detail sectional view of a discharging portion. Each of the drop discharging heads 51 is a inkjet type drop discharging head. Each of the drop discharging heads 51 is provided with an oscillation plate 126 and a nozzle plate 128. A liquid storage 129 is placed between the oscillation plate 126 and the nozzle plate 128. The first conductive liquid material 11a, the insulating liquid material 11b, and the second conductive insulating material 11c are supplied to a hole 131 from the tank 12 via the tube 13 and always filled in the liquid storage 129. Each of liquid materials is supplied to each of different droplet discharge heads 51.

A plurality of partitions 122 are placed between the oscillation plate 126 and the nozzle plate 128. A region surrounded by the oscillation plate 126, the nozzle plate 128 and a pair of partitions 122 is a cavity 120. The cavity 120 is installed opposing to the nozzle 52 so that the numbers of the cavity 120 is equal to a number of the nozzle 52. The first conductive liquid material 11a, the insulating liquid material 11b, and the second conductive insulating material 11c are supplied to the cavity 120 from the liquid storage 129 via a supply port 130 located between a pair of partitions 122.

In the FIG. 2B, the oscillator 124 is located opposing to the cavity 120 on the oscillation plate 126. The oscillator 124 comprises a pair of electrodes 124a and 124b sandwiching a piezo element 124c. A driving voltage is applied to a pair of electrodes so that the first conductive liquid material 11a, the insulating liquid material 11b, and the second conductive insulating material 11c are discharged from the nozzle 52. The configuration of the nozzle 52 is arranged so that the first conductive liquid material 11a, the insulating liquid material 11b, and the second conductive insulating material 11c are discharged to Z-axis from the nozzle 52.

In this specification, the first conductive liquid material 11a, the insulating liquid material 11b, and the second conductive insulating material 11c are defined as a material having a viscosity to the level of being discharged from the nozzle. Such material is either aqueous or oiliness. If the material has sufficient flowability for being charged from the nozzle, it may include some solid material. Details are described later.

In the specification, a discharging portion 127 may be defined as a part including one nozzle 52, the cavity 120 corresponding to the nozzle 52, and the oscillator 124 corresponding to the cavity 120. According to this definition, a single of the droplet discharging heads 51 has the discharging portion 127 of which numbers are equal to the numbers of the nozzle 52. The discharging portion 127 may comprise electro-thermal conversion element instead of piezo element. Namely, the discharging portion 127 may be structured so as to discharge a material by using thermal expansion of a material with an electro-thermal conversion element.

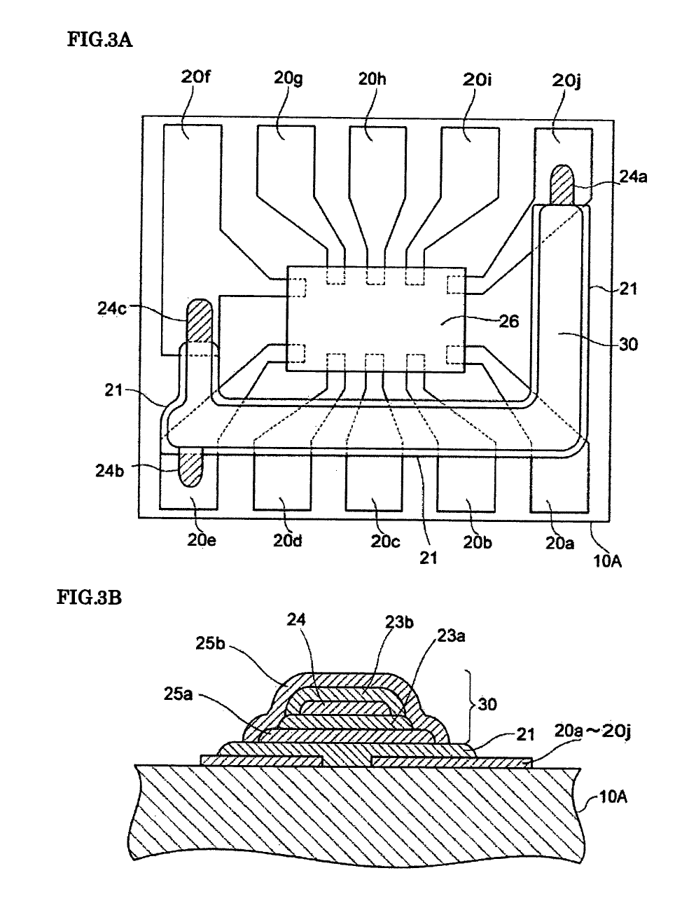

FIG. 3A is a partial plane view of a shield wire installed in a circuit board. FIG. 3B is a partial cross sectional view of a shield wire installed in a circuit board or a container of an electronic instrument. In the embodiment, the discharged member is the circuit board, buy it may be or a container of an electronic instrument. Conductive patterns 20a to 20j are installed as an electrical wiring on the circuit board 10A and IC package 26 is mounted in the center of it. The tank 12 in the droplet discharging device 1 (shown in FIG. 1) stores a plurality of liquid materials. The insulating liquid material 11b is selected from them and discharged on the circuit board 10A as a discharged member. The insulation layer 21 is formed on a appropriate area of the conductive patterns 20a to 20j.

The insulating liquid material 11b is selected from SiO₂, SiN,Si₃N₄, polyamide resin, polyester resin, phenol resin, fluorine resin, UV ray cured resin and visual light cured resin after thermal and/or optical processing so as to insure adhesiveness to the circuit board 10A or conductive patterns 20a to 20j. Further, the insulating liquid material 11b is not limited to these materials, but any materials insuring electric insulation. Viscosity of the insulating liquid material 11b, a dispersion medium or a solvent for it, concentration of dispersion, and a material for arranging surface tension are the same of them for the second conductive liquid material 11c described later. When an insulating coat 22 is already formed on the conductive patterns 20a to 20j, the insulation layer 21 is omitted.

Next, the second conductive liquid material 11c is selected from a plurality of liquid materials stored in the tank 12 of the droplet discharging device 1 by the droplet discharging device 1. The second conductive liquid material 11c, which contains at least conductive fine particles or organic metal compounds is discharged as a predetermined configuration on a predetermined location of the circuit board 10A so as to be a second conductive wiring 25a. The second conductive liquid material 11c, which contains at least conductive fine particles or organic metal compounds, comprises a dispersion liquid where conductive fine particles are dispersed, a liquid organic metal compound, a solution of it or mixture of them. Conductive fine particles are selected from a metal particles such as gold, silver, tin, palladium, nickel or conductive polymer or super conductive material.

An organic material may be coated over the surface of these conductive fine particles in order to improve dispersion. A coating material for coating the surface of these conductive fine particles is selected from organic solvent such as xylene, toluene and citric acid. The size of a conductive fine particle is favorably more than 1 nm and under 0.1 micron. If the size is more than 0.1 micron, the particles are frequently stopped at the nozzle of a droplet discharging heads of the inkjet droplet discharging device and not discharged easily. Further, when the size is less than 1 nm, the volume ratio of coating material to the conductive fine particles becomes large and the ratio of organic material become large.

Organic metal compounds are a compound and an aqua complex including gold, silver and palladium. Metals within them are revealed by thermal decomposition. In detail, chloro triethyl phosphine gold (I), chloro trimethyl phosphine gold (I), chloro triphenyl phosphine gold (I),silver(I)2,4-pentanedionato aqua complex, trimethyl phosphine(hexafluoro acetyl ATA)silver(I) aqua complex, and cupper (I) hexafluoro pentanedionato cycloocta diene aqua complex are cited.

Vapor pressure of dispersion medium or solvent including at least conductive fine particles or organic metal compound at room temperature is favorably more than 0.001 mmHg and less than 200 mmHg (more than 0.133 Pa less than 26600 Pa.) If vapor pressure is higher than 200 mmHg, a dispersion medium or a solvent is suddenly evaporated making a liquid difficult deposited as a favorite film. Further, vapor pressure of dispersion medium or solvent is favorably more than 0.001 mmHg less than 50 mmHg (more than 0.133 Pa less than 6650 Pa). If vapor pressure is higher than 50 mmHg, the particles are frequently stopped due to drying at the nozzle of a droplet discharging heads of the inkjet droplet discharging device and not discharged stably. On the other hand, when vapor pressure of dispersion medium and/or solvent at room temperature is less than 0.001 mmHg, drying is delayed so that dispersion medium and/or solvent are easily hold, and it is not easy to obtain high quality conductive layers after the post process such as thermal or optical processing.

A dispersion medium is not specifically limited if it can disperse the conductive fine particles and does not make particles aggregate. A solvent is not specifically limited if it can dissolve the organic metal compound. Such dispersion medium and/or solvents are water, alcohol such as methanol, ethanol, propanol, butanol, carbon hydride compound such as n-heptanes, n-octane, decane, toluene, xylene, cymene durren, inden, dipenten, tetrahydro naphthalene, decahydro naphthalene and cyclohexyl benzen and eter compound such as ethleneglycol dimethyl eter, ethleneglycol diethyl eter, ethleneglycol methyl ethyl eter, diethleneglycol dimethyl ethyl eter, diethleneglycol diethyl eter, diethleneglycol methyl ethyl eter, 1,2-di methoxy ethane, bis (2-methoxy ethyl) eter, and p-dioxane and a polar compound such as propylene carbonate, γ butyrolactone, N-methyl-2 pyrrolidone, dimethyl formamide, dimethyl sulfoxide, cyclo exanoate. Further, polyamide resin, epoxy resin, polyester resin, phenol resin, fluorine resin, UV cured resin, and visible light resin are cited. Water, alcohol, carbon hydride compound and eter compound among them are favorite in view of dispersion of fine particles, stable solution, easy soluble organic metal, appropriateness for applying to a droplet discharging method. Water and carbon hydride compound are further favorite as a dispersion medium or solvent. These dispersion medium or solvents are used independently or as a mixture of more than two kinds.

A dispersion concentration for dispersing the conductive fine particles into dispersion medium is favorably more than 1 weight % less than 80 weight %, can be adjusted depending on desired thickness of a conductive layer. When it is over 80 weight %, the conductive fine particles easily aggregate, making a film difficult being uniform. As the same reason, solute concentration for the organic metal solution is favorably the same range of the dispersion concentration. The surface tension of the second conductive liquid material 11c, which includes at least the arranged conductive fine particles or the organic metal compound, is favorably more than 0.02 N/m and less than 0.07 N/m. When the second conductive liquid material 11c is discharged by a droplet discharging method and the surface tension is less than 0.02 N/m, a droplet of the liquid easily veeringly flies from the nozzle to the circuit board 10A because of the increase of wettability of ink compound to the nozzle surface. When the surface tension is more than 0.07 N/m, ink configuration due to the surface tension at the nozzle tip is not stable, making the discharging amount and timing control of discharging difficult.

In order to arrange the surface tension, materials for arranging the surface tension such as fluorine, silicon, nonion groups may be added to a liquid material so as to avoid decreasing contact angle with the surface of the circuit board 10A. A nonion group material for arranging the surface tension improves the wettability of the liquid material toward the circuit board and the leveling property of the film, and prevents the coated film from having of uneven surface like an orange peel (including small dints on a surface.)

The viscosity of the liquid material is favorably more than 1 mPa·s and less than 50·m·Pa·s. When the viscosity is over 1 mPa·s, it is uneasy that the circumference of the nozzle 52 is contaminated by the flow of the liquid material at the time of discharging the droplet 11 of the liquid material (shown in FIG. 2.) Meanwhile, when the viscosity is less than 50·mPa·s, the droplet is not easily stopped at the nozzle 52 so as to attain smooth discharging.

Further, when the insulation coat 22 is covered over the circuit board 10A, the kind of the solvent for the second conductive liquid material 11c is the same material for insulation coat 22, attaining favorite adhesiveness toward the insulation coat 22. The second conductive liquid material 11c is discharged and formed by the discharging droplet device 1, so that the second conductive wiring 25a is formed as a favorite conductive film after thermal and/or optical treatment.

Next, the insulating liquid material 11b is selected from a plurality of liquid materials stored in the tank 12 in the droplet discharging device 1 (shown in FIG. 1) and the insulation portion 23a is discharged and formed. The material for it may be the same of the insulation layer 21 or different. The insulation layer 21 may certainly assures the adhesiveness of the circuit board 10A toward conductive patterns 20a to 20j and the second conductive wiring 25a. The insulation liquid material 11b discharged from the droplet discharging device 1 as the insulation portion 23 may certainly assure the adhesiveness with the second conductive wiring 25a and electrical insulation.

Next, the first conductive liquid material 11a is selected from a plurality of liquid materials stored in the tank 12 in the droplet discharging device 1 (shown in FIG. 1), discharged and formed on the insulating portion 23 so as to form the first conductive wiring 24. The material for the first conductive liquid 11a may be the same of the second conductive liquid material 11c or different. The first conductive wiring 24 is connected to the conductive patterns located on the circuit board 10A and passes electric current. Hence, the first conductive wiring 24 has favorably superior conductivity.

Next, the insulation liquid material 11b is selected from a plurality of liquid materials stored in the tank 12 in the droplet discharging device 1 (shown in FIG. 1), discharged and formed at least on a region including the insulating portion 23a and the first conductive wiring 24 so as to form the insulating portion 23b. Hence, the other direction of the first conductive wiring 24 except both ends of long direction of it is encompassed by the insulation portions 23a and 23b. Namely, the first conductive wiring 24 is electrically insulated from the second conductive wiring 25a by the insulation portions 23a and 23b.

Next, the second conductive liquid material 11c is selected from a plurality of liquid materials stored in the tank 12 in the droplet discharging device 1 (shown in FIG. 1), discharged and formed at least on a region including the insulating portions 23a and 23b and the second conductive wiring 25a so as to form the second conductive wiring 25b. Hence, the insulating portion 23a and 23b is encompassed by the second conductive wirings 25a and 25b. The other direction of the insulating portions 23a and 23b except both ends of long direction of it is encompassed by the second conductive wirings 25a and 25b. Namely, the insulation portions 23a and 23b are sandwiched by the first conductive wiring 24 and the second conductive wirings 25a and 25b. The first conductive wiring 24 is electrically insulated from the second conductive wirings 25a and 25b by the insulation portions 23a and 23b to be the shield wire 30.

FIG. 3B shows the connection of conductive patterns 20e to 20j to the shield wire 30. The insulation coat 22 is not formed over the conductive patterns 20a to 20j. Here, when the shield wire 30 is formed between the conductive pattern 20e and 20j, the conductive pattern is electrically short circuited because of electrical conductivity of the second conductive wiring 25a. In order to avoid the short circuit, the insulation layer 21 is formed at least in an area where the shield wire 30 is overlapped with conductive patterns. The insulation layer 21 may not be formed, when the conductive pattern is not short circuited with the conductive wiring 25a because of the insulating coat 22.

At the electrical connections 24a and 24b between the shield wire 30 and conductive patterns 20e to 20j, the insulation layer 21 is not formed and the first conductive wiring 24 is electrically connected to the conductive patterns 20j and 20e. The second conductive wirings 25a and 25b are installed within a region of the insulating layer 21 at the both ends of the shield wire 30 so as to avoid electrical short circuit to the first conductive wiring 24. The second conductive wirings 25a and 25b are connected to the conductive pattern 20f, which is the electrical ground of the circuit board 10A at the connection 24c. Thus, the second conductive wirings 25a and 25b are electrically grounded.

An advantage of the embodiment 1 is the following: Various kinds of noises are generated by signals ands current passing through the first conductive wiring 24. In the present embodiment, in order to prevent electronic devices from such noise, the first conductive wiring 24 is encompassed by the insulating portions 23a and 23b and the circumference of it is also encompassed by the second conductive wirings 25a and 25b. Further, the second conductive wirings 25a and 25b are grounded by the connection 24c. Therefore, the embodiment provides a shield wire, which can give the countermeasure against noise caused by the wiring in an electronic instrument.

### Second Embodiment

A second embodiment of the invention will now be described with reference to the accompanying drawings. Here, only a portion and a part that are different from the embodiment 1 can be described.

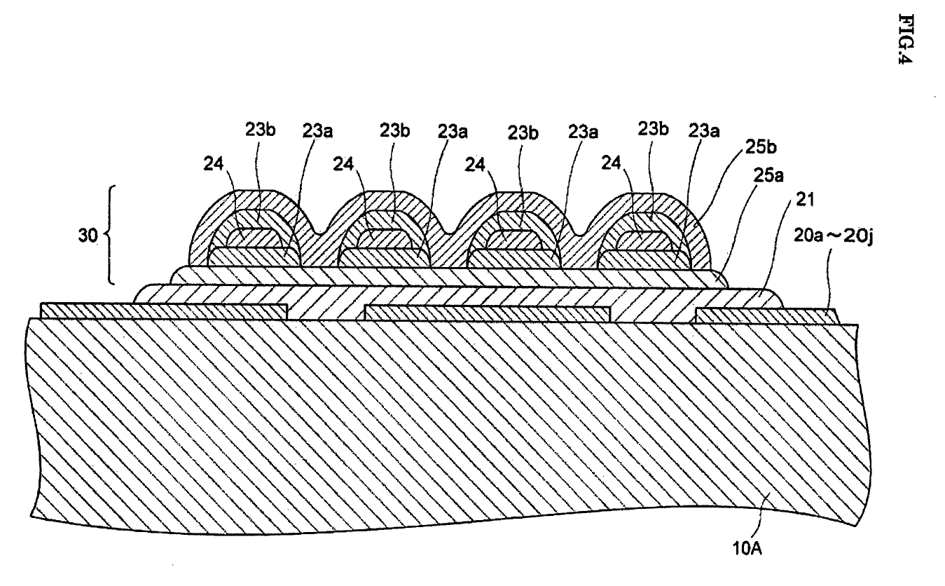

FIG. 4 is a cross sectional view of enlarged part of the shield wire 30. In the embodiment, a plurality of the first conductive wirings 24 are installed between the second conductive wirings 25a and 25b. The insulating liquid material 11b is discharged on an area where insulation is necessary among conductive patterns 20a to 20j formed on the circuit board 10A. Then, the insulation layer 21 is formed. The second conductive liquid material 11c is discharged on the insulation layer 21 by the droplet discharging device 1. Then, the second conductive wiring 25a is formed. In this case, the width of the second conductive wiring 25a is equal to the size of installing four of the first conductive wirings 24.

Next, the insulating liquid material 11b is discharged on the second conductive wiring 25a by the droplet discharging device 1. Then, the insulation portion 23 is formed. It is installed corresponding to the first conductive wiring 24 which is described later. The insulation portions 23a may have different widths. They also may have different pitches.

Next, the first conductive liquid material 11a is discharged by the droplet discharging device 1. Then, four of the first conductive wirings 24 are formed. Further, four of the insulating portions 23b are installed corresponding to the four of the first conductive wirings 24. Here, it is important that the insulation portion 23 does not contact with the adjacent insulating portion 23. If the insulation portion 23b contacts with the adjacent one, it becomes impossible that the second conductive wiring 25 encompasses the first conductive wiring 24 and does not function as shielding.

Next, the second conductive liquid material 11c is discharged encompassing all the second conductive wiring 25a, the insulation portions 23a and 23b and a plurality of the first conductive wiring 24. Then, the second conductive wiring 25b is installed so as to form the shield wire 30 having a plurality of the first conductive wirings 24.

An advantage of the embodiment 2 is the following: The second conductive wirings 25a and 25b are discharged at once, making discharging time short. If the second conductive wiring 25b is electrically grounded at one place, the shield wire 30, which can take noise countermeasure toward all the first conductive wirings 24, can be provided.

### Third Embodiment

A third embodiment of the invention will now be described with reference to the accompanying drawings. Here, only a portion and a part that are different from the embodiment 1 can be described.

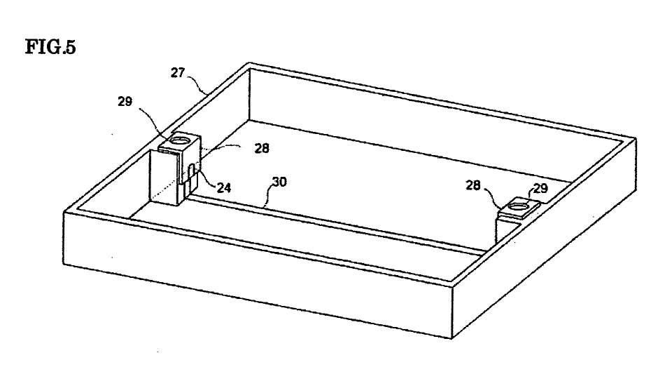

FIG. 5 is a perspective view of installing the shield wire 30 in a container of an electronic device. In the embodiment, the shield wire 30 is installed in the container 27 of an electronic instrument and a part of the container 27 is used as a circuit. In the container 27 of an electronic instrument, a pair of holes (not shown) for fixing other container with a screw connects the screw cramp hole 29 provided in the metal plate 8. Namely, the container 27 can be linked to other one by being cramped with a screw from the lower area of the container 27. Further, other container includes electrical conductive portion facing the metal plate 28 and be electrically connected to the container 27 by being linked.

For example, the shield wire 30 is installed encompassing a pair of metal plate 28. In this case, the droplet discharging head 51 (shown in FIG. 2) of the droplet discharging device 31 is mounted at the end of an arm of the articulated robot. The first conductive liquid material 11a, the second conductive liquid material 11c and the insulating liquid material 11b, which are stored in the tank, are provided and discharged toward the vertical direction or the horizontal direction.

A part of the first conductive wiring 24 of the shield wire 30 is installed so as to be electrically connected to a part of a pair of metal plate 28. When a material of the container is plastic, there is no need of the insulating layer 21 between the shield 30 and the container 27. When a material of the container is metal, there needs the insulating layer 21 between the shield 30 and the container 27.

In the embodiment, a pair of the metal plates 28 is explained, but a plurality of metal plates 28 can be prepared for installing the shield wire 30 of the embodiment inside and/or outside of the container. The connection is not limited to the metal plate 28, can be replaced with a circuit broad for a power source and a display, transformer, a container for an electronic instrument, a memory device and operating switch. The embodiment can be applied to a means for removing electrostatic generated in a display. In this case, it is better that the insulator 21 is not installed between the shield 30 and the display. Further, the device is directly connected via the first conductive wiring 24 without installing the metal plate 28.

An advantage of the embodiment 3 is the following: When a plurality of circuit boards are connected each other in the electronic instrument, the present embodiment is to provide the shield wire 30 for avoiding noise.

### Fourth Embodiment

A fourth embodiment of the invention will now be described with reference to the accompanying drawings. Here, only a portion and a part that are different from the embodiment 1 can be described.

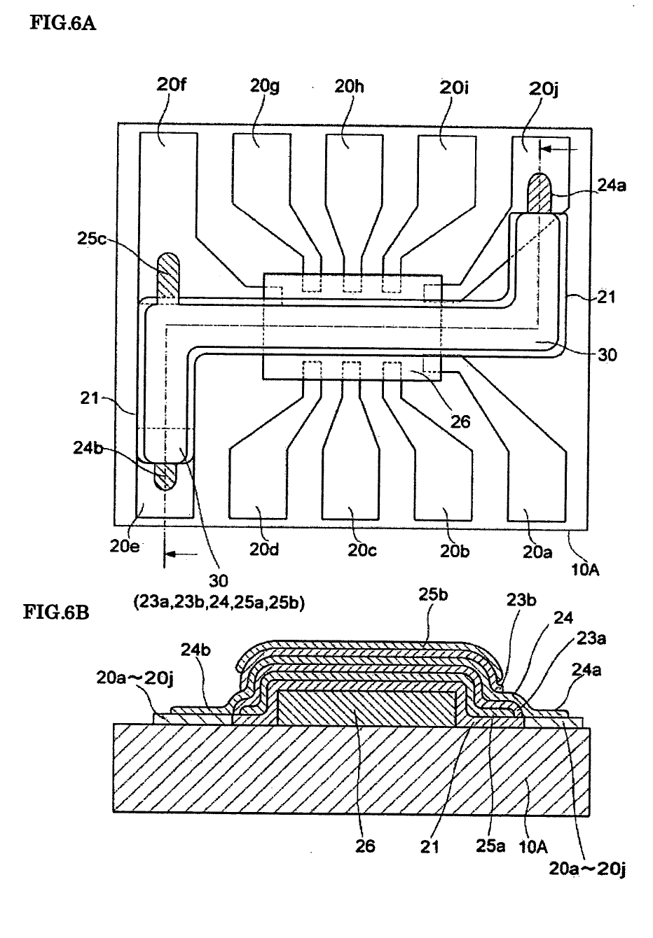

FIG. 6A is a plane view of electronic elements mounted on the circuit board 10A, which is a discharged member of the shield wire 30. FIG. 6B is a partial cross sectional view of it. In this embodiment, conductive patterns as wrings of the circuit board 10A are electrically connected each other with passing via the IC package 26 as an electronic element mounted on the circuit board 10A. For example, when conductive patterns 20j to 20e are connected each other by the shield wire 30, the shield wire 30 is installed in a region over the IC package 26 as an electronic element mounted on the circuit board 10A, if there is no other space for installing it over the other conductive patterns. The shield wire 30 is formed by the discharging method disclosed in the embodiment 1. In the embodiment, the second conductive patterns 20a and 20f are installed between the conductive patterns 20j and 20e and they are short circuited with the second conductive wiring 25a. The insulation layer 21 is installed between the shield wire 30 and the circuit board 10A in order to avoid the short circuit. The first conductive wiring 24 is connected to the conductive pattern 20j via the connection 24a and the conductive pattern 20e via the connection 24b. The second conductive pattern 25b is electrically connected to the conductive pattern 20f, which makes the circuit board 10A grounded, via the connection 25c.

The present embodiment can be applied to a installation for a back light and a reflector opposing the display surface of a display device, transformer and a capacitor.

An advantage of the embodiment 4 is the following: A space over electronic elements is used for the shield wire 30 for noise countermeasure so as to miniaturize an electronic instrument.

What is claimed is:

1. A shield wire comprising:
a first conductive wiring that is formed by discharging with a droplet discharging device, for passing electric current or an signal;
a second conductive wiring that is formed by discharging with a droplet discharging device; and
an insulating portion formed between the first conductive wiring and the second conductive wiring by discharging with a droplet discharging device.

2. The shield wire according to claim 1, further comprising an insulating layer that is formed by discharging with a droplet discharging device, between the second conductive wiring and a discharged member that is formed by discharging with the droplet discharging device.

3. The shield wire according to claim 1, wherein the discharged member is a circuit board.

4. The shield wire according to claim 1, wherein the discharged member is a container for an electronic instrument.

5. The shield wire according to claim 1, wherein the discharged member is an electronic element.

6. The shield wire according to claim 1, wherein a plurality of the insulating portions is provided between the first conductive wiring and the second conductive wiring.

7. The shield wire according to claim 1, wherein the second conductive wiring is electrically grounded.
